(19) United States
(12) Patent Application Publication
(10) Pub. No.: US 2024/0067018 A1
(43) Pub. Date: Feb. 29, 2024

(54) Device for automatic positioning of a charge plug

(71) Applicant: Webasto SE, Stockdorf (DE)

(72) Inventors: Michael Finsinger, Stockdorf (DE); Andreas Albrecht, Stockdorf (DE); Frank Schubert, Stockdorf (DE)

(21) Appl. No.: 18/272,299

(22) PCT Filed: Jan. 14, 2022
(86) PCT No.: PCT/EP2022/050771

§ 371 Date: Jul. 13, 2023

(30) Foreign Application Priority Data
Jan. 14, 2021 (DE) 10 2021 100 705.4

(51) Int. Cl. B60L 53/35; B60L 53/16; B60L 53/66

(52) U.S. Cl. CPC B60L 53/35; B60L 53/16; B60L 53/66

(57) ABSTRACT

The present invention relates to a computer program product, method, and device for automatic positioning of a charge plug, arranged on a movable arm of a ground station, into a socket of a vehicle unit of an electric vehicle arranged thereabove, where the device comprises a control unit, which is designed and configured to control the movement of the movable arm and/or the charge plug, and a sensor device communicating with the control unit for detecting the positioning of the charge plug relative to the socket.

### CROSS-REFERENCE TO RELATED APPLICATIONS

This application is a 35 U.S.C. § 371 National Stage Entry of International Application No. PCT/EP2022/050771 filed Jan. 14, 2022, which claims the priority benefit of German Patent Application Serial Number DE 10 2021 100 705.4 filed Jan. 14, 2021, all of which are incorporated herein by reference in their entirety for all purposes.

### TECHNICAL AREA

The present invention relates to a device for automatic positioning of a charge plug arranged on a movable arm of a ground station into a socket of a vehicle unit of a mobile chargeable unit arranged thereabove, in particular of an electric vehicle, wherein a control unit is provided, which is designed and configured to control the movement of the movable arm and/or the charge plug, and a magnetic sensor device communicating with the control unit is provided for detecting the positioning of the charge plug relative to the socket. The present invention furthermore relates to a method for automatic positioning of a charge plug, arranged on a movable arm of a ground station station, into a socket of a vehicle unit of an electric vehicle. In addition, the present invention relates to a computer program product for executing the steps of the method.

### BACKGROUND

When using battery-operated electric vehicles, it is necessary to charge the batteries accommodated in the electric vehicle, which are provided to supply the electric drive of the electric vehicle.

In conventional electric vehicles, charging of the battery is achieved in that the electric vehicle is parked at a charging column or a wall box and then the user establishes a connection between the charging column or the wall box and the electric vehicle by manually plugging in a corresponding charge plug. The actual charging process can then be started.

To automate the procedure of connecting the electric vehicle, and thus to save time and effort of the user and increase the level of comfort, different devices for automatically connecting electric vehicles to a charging device are known.

Robot arms having attached plugs are known for automatically connecting electric vehicles to charging devices, which enable automatic positioning of the plug into a socket of an electric vehicle and thus automatically start the charging process. In practice, however, it has been shown that with such robot arms the fine positioning of the plug is susceptible to contamination. Optical and acoustic sensors, which require a high signal quality to function perfectly, are often used for automatic positioning. In addition, in particular in the case of optical sensors, a high level of computing effort for the image processing and high costs for the hardware components arise. As a result, an additional user interaction is often necessary in practical use of robot arms to successfully start the charging process.

### DESCRIPTION OF THE INVENTION

It is therefore an object of the invention to provide a device for automatic positioning of a charge plug, arranged on a movable arm of a ground station, into a socket of a vehicle unit of an electric vehicle arranged thereabove, which enables reliable operation.

The object is achieved by a device for automatic positioning of a charge plug arranged on a movable arm of a ground station into a socket of a vehicle unit of an electric vehicle arranged thereabove, having the features of claim 1. Advantageous embodiments follow from the dependent claims, the following illustrations, and the description of a preferred exemplary embodiment.

Accordingly, a device is proposed for automatic positioning of a charge plug, arranged on a movable arm of a ground station, into a socket of a vehicle unit of an electric vehicle arranged thereabove, wherein a control unit is provided, which is designed and configured to control the movement of the movable arm and/or the charge plug, and a sensor device communicating with the control unit is provided for detecting the positioning of the charge plug relative to the socket.

According to the invention, the sensor device is designed and configured so that an alignment of the charge plug relative to the socket is detectable. Furthermore, the control unit is designed and configured to perform automatic positioning of the charge plug relative to the socket on the basis of the detected alignment. The detection is based on a determination of the distance of the charge plug to the socket.

The ground station may be, for example, entirely or partially embedded in the ground of a roadway or a parking surface or may be arranged on the roadway or the parking surface and the movable arm of the ground station may be moved out of the ground station within a predetermined range of motion. In this case, the “vehicle unit arranged thereabove” of the electric vehicle is to be understood as a vehicle unit which is arranged in an electric vehicle, which is positioned, in particular parked, above the ground station.

Nonetheless, the ground station may, for example, be entirely or partially embedded in a wall or ceiling structure and the movable arm may be moved out of the wall or ceiling structure. The term “ground station” may therefore also be understood more generically in the meaning of the present disclosure as a “base station”. Accordingly, the wording “arranged thereabove” is to be understood from the perspective of the ground station.

In the meaning of the present disclosure, the plane of the ground station is defined as the X-Y plane and the normal direction of this plane as the Z direction.

Furthermore, in the meaning of the present disclosure, the alignment of the charge plug may be understood as a positioning specification, which additionally includes an angle around the Z axis in a plane parallel to the X-Y plane. If the ground station is located, for example, in the floor or on a ceiling structure, the alignment may therefore correspond to a position which, on the one hand, contains a relative position between charge plug and socket and, on the other hand, contains an approach angle, in which the electric vehicle was parked.

In particular, the detected alignment may thus permit an inference as to whether the electric vehicle was parked forward or in reverse with respect to the ground station. In other words, it can be ensured by the detected alignment that a collision-free and secure contacting of the charge plug in the socket is achieved independently of how the vehicle was parked with respect to the ground station.

A sensor device may be understood in the meaning of the present disclosure as any sensor-receiver pair, which permits a sufficiently precise inference about the distance between sensor and receiver.

It is not of particular importance to accurately quantify the distance between the transmitter and the receiver, but rather a dynamic determination as to whether it may be identified whether sensor and receiver move away from one another or move toward one another or are moved at equal distance in relation to one another during operation, may initially be sufficient. A precise quantification of the distance is also possible, however.

Because the sensor device is designed and configured such that an alignment of the charge plug relative to the socket is detectable, the device may detect all position data by means of the sensor device, which are necessary for automatic positioning of the charge plug into the socket.

Because the control unit of the device is designed and configured to perform automatic positioning of the charge plug relative to the socket on the basis of the detected alignment, the previously detected alignment may be deliberately used to automatically perform the positioning. Therefore, reliable automatic positioning of a charge plug arranged on a movable arm of a ground station into a socket of a vehicle unit of an electric vehicle arranged thereabove may take place quickly and reliably with arbitrary alignment of the socket relative to the charge plug. Nonetheless, the automatic positioning of a charge plug arranged on a movable arm of the ground station may take place in that the ground station is moved accordingly. In this case, the movable arm may be spatially fixed or movable relative to the ground station.

The automatic positioning may include translational and/or rotational movement directions here. Translational movements may include one-dimensional, two-dimensional, and three-dimensional vectors. Rotational movements may take place clockwise and/or counterclockwise. The rotational movement may take place around a main axis, in particular the Z axis. In principle, the rotational movement may also take place around any arbitrary axis. In particular, rotational and translational movements may also take place superimposed, for example in the form of a screwing-in movement.

According to one advantageous embodiment, the sensor device is a magnetic sensor device. In the meaning of the present disclosure, a magnetic sensor device may be understood as a sensor device which permits an identification and/or an indication about the relative spatial distance between a sensor and a receiver by utilization of magnetic fields. More precisely, an indication about the relative spatial distance between sensor and receiver can be made by detecting and analyzing the field strengths of magnetic fields.

For example, a magnetic sensor device in the meaning of the present disclosure may be understood as an analog magnetic sensor in the ideal case, for example an analog Hall sensor. Such devices detect static or variable field strengths of magnetic fields. Contactless and wear-free position detection may be carried out by the use of a magnetic sensor device. Furthermore, magnetic fields may therefore also be detected through various materials, for example plastic, wood, or even non-magnetizable metals such as nonferrous metal, aluminum, and stainless steel. A protective envelope may thus be attached around the sensors, by which the service life of the device is significantly improved. In addition, magnetic sensor devices are particularly robust, have a long usage time, and are insensitive to dirt. Magnetic sensor devices are capable of detecting alternating magnetic fields. The first rough positioning of the device may be implemented automatically very quickly via a magnetic “signal”, which is generated in the vehicle unit, for example, using permeated coils.

According to one advantageous embodiment, the magnetic sensor device comprises at least two magnets and at least two analog Hall sensors, wherein the magnets and the Hall sensors are preferably arranged such that a predetermined position of the charge plug relative to the socket is detectable by means of the magnetic sensor device of a magnet-Hall sensor pair.

The Hall sensor is preferably an analog Hall sensor, which outputs an analog signal corresponding to a field strength of a magnetic field. In the simplest case, the magnet may in be a permanent magnet. For example, the analog output may be, for example, a voltage or an electrical current, which corresponds to a field strength, for example, specified in tesla. The Hall sensor therefore functions as a proximity sensor, with the aid of which the spatial distance, thus both in the X-Y plane and in the Z-axis direction may be determined between magnet and Hall sensor. Nonetheless, the charge plug is primarily moved in a two-dimensional plane, the X-Y plane, for detecting the position.

The magnet may preferably also be an electromagnet, in which the magnetic field strength may be changed by current change, by which a specific signal may be applied to each magnet, due to which the individual magnet may be uniquely identified or is distinguishable from other magnets.

If more than two magnets are used, electric magnets are preferably to be used for this purpose, which are activated in a defined manner in a suitable manner and at a suitable time to generate a magnetic field unique to the electric magnet.

Magnets and Hall sensors are to be understood in the meaning of the present disclosure as components of the magnetic sensor device. The magnetic sensor device therefore comprises at least one proximity sensor, which can be formed from a magnet and a complementary Hall sensor. A special magnet does not always have to be assigned to a special Hall sensor. Rather, a proximity sensor may be formed from the combination of an arbitrary magnet with an arbitrary Hall sensor. A magnet may be understood in the meaning of the present disclosure, for example, as a permanent magnet or a magnet resulting from an arbitrarily shaped coil through which current flows. One advantage of the electrically generated magnetic field is that both the magnetic field strength and the orientation may be changed.

If a magnetic field of a magnet reaches a sufficiently close vicinity of a Hall sensor, the field strength of the magnetic field is detected by means of the magnetic field sensor. This can occur, for example, when a charge plug is moved relative to the socket into a predefined position in the meaning of the present disclosure. In the meaning of the present disclosure, a predefined position is to be understood as a range of positions within which a magnet may be detected by a Hall sensor/magnetic field sensor. In the meaning of the present disclosure, this case is designated as the detection of a magnet-Hall sensor pair by means of the magnetic sensor device.

The detection of a magnet-Hall sensor pair by means of the magnetic sensor device is furthermore to be understood as a detection of the spatial position of this magnet-Hall sensor pair. The spatial reference system may be an absolute or relative reference system. The reference system may be one-dimensional, two-dimensional, or three-dimensional. For example, the detection of a magnet-Hall sensor pair by means of the magnetic sensor device may comprise the detection of a three-dimensional coordinate in a Cartesian X-Y-Z coordinate system. Nonetheless, other coordinate systems are also conceivable.

The magnets and the Hall sensors are arranged in equal numbers either on the charge plug or on the socket. This means that the total quantity of components which comprise both magnets and Hall sensors is to be split equally among charge plug and socket. The component-related allocation onto charge plug and socket is however fundamentally unimportant for the function of the present disclosure.

Because the magnets and the Hall sensors are arranged in equal proportions on the charge plug and on the socket, multiple different magnet-Hall sensor pairs may be detected, due to which further findings with respect to the spatial position of the charge plug relative to the socket may be made on the basis of the positions.

The use of Hall sensors has the advantage that they operate in a contactless manner and therefore do not exhibit friction and therefore experience no wear. Hall sensors are cost-effective and independent with respect to weather influences. In addition, Hall sensors are capable of reliably generating signals without the necessity of a calibration of the acquired signals.

According to one advantageous embodiment, precisely two magnets are arranged on the charge plug and precisely two Hall sensors are arranged on the socket. Due to the arrangement of the magnets on the charge plug, cables do not have to be guided on the movable arm and on the charge plug, due to which the complexity and weight of the moved arm is further reduced. The magnets are each arranged spaced apart from one another and in different north-south orientation and the Hall sensors are also arranged spaced apart from one another. With suitable movement of the charge plug relative to the socket, precisely four different magnet-Hall sensor pairs may thus be detected by means of the magnetic sensor device, by which the relative position between charge plug and socket may be determined accurately.

Because precisely two magnets and precisely two Hall sensors are provided, the detection of the alignment of the charge plug relative to the socket may be achieved unambiguously. A detection can take place, for example, such that relative position data of the charge plug to the socket may be detected by means of translational movement and rotational movement of the movable arm in the X-Y plane.

According to one advantageous embodiment, the magnets are arranged at a first distance in relation to one another and the Hall sensors are arranged at a second distance in relation to one another, wherein the first distance preferably corresponds to the second distance.

A position of the plug relative to the socket can thus be determined in which a center point of the plug, together with the two Hall sensors, forms an equilateral, right-angle triangle. In this position, for example, it can be ensured by rotating the plug that both magnets are movable above both Hall sensors.

According to one advantageous embodiment, the magnets have an opposing polarity in relation to one another, wherein the Hall sensors are bipolar analog Hall sensors. An opposing polarity of the magnets means that one magnet is a north pole magnet (+) and the other magnet is a south pole magnet (−). Bipolar Hall sensors generate a positive or negative output signal depending on the polarity of the applied magnetic field. The output signal can be a voltage relative to the magnetic field strength, a frequency or a duty cycle of a PWM signal. Furthermore, the values of the field strength may also be output digitally or in any other manner. It is therefore possible to detect unambiguously by means of the magnetic sensor device which magnet presently forms a magnet-Hall sensor pair at which bipolar Hall sensor. By suitably moving the charging plug, detecting a further pair of magnetic Hall sensors by means of the magnetic sensor device can, for example, indicate whether the socket is in a “normal” or in an “upside down” position. Specifically, it may thus be established by means of the device, for example, which position the charge socket is in relative to the charge plug.

A metallic plate for amplifying the magnetic field is according to an advantageous embodiment arranged behind each Hall sensor. A metallic plate in the meaning of the present disclosure can be understood, for example, as an iron plate. Experimental studies of the applicant have shown that the provision of a metallic plate results in an amplification of the magnetic field which can be induced at the Hall sensor via a magnet. Both the measurement accuracy and the sensitivity of the Hall sensor can thus be increased, or the Hall sensors can be made smaller at equal signal strength.

According to an advantageous embodiment, the charge plug includes a head end, wherein preferably the components of the magnetic sensor device which are arranged on the charge plug are arranged symmetrically to a center point of the charge plug.

According to an advantageous embodiment, the movable arm is movable within a predefined virtual range of motion, wherein the predefined virtual range of motion preferably has a cross section of 300×300 mm. The first magnet-Hall sensor pair can be detected, for example, by routine or random travel along the charge plug. Because the movable arm is only movable within a predefined virtual range of motion, a scanning routine can be ended faster. The predefined range of motion can be defined, for example, relative to the ground station. The movement space can thus be identified for the operator of a vehicle, due to which the operation of the device is possible more easily and faster.

In a further advantageous embodiment, a control unit is provided for controlling the arm and/or the charge plug and/or for processing signals of the magnetic sensor device. A detection of a magnet-Hall sensor pair by means of the magnetic sensor device may thus be used as a variable in a control loop for automatical positioning of the charge plug into the socket. The control unit can comprise multiple subunits, which can be arranged in the ground station and/or the vehicle unit.

The ground station and/or the vehicle unit advantageously include communication devices for data transmission, wherein the data transmission preferably includes a wireless data transmission. A detection of a magnet-Hall sensor pair by means of the control unit, which takes place in a vehicle, for example, can thus be transmitted in a contactless manner to a component of the device external to the vehicle. Furthermore, activation of the device can be enabled via the communication devices for data transmission.

The object stated above is furthermore achieved by a method for automatic positioning of a charge plug, arranged on a movable arm of a base station, into a socket of a vehicle unit of an electrical vehicle arranged thereabove. Advantageous embodiments of the method result from the dependent claims and the present description and the figures.

Accordingly, a method for automatic positioning of a charge plug, arranged on a movable arm of a ground station, in a socket of a vehicle unit of an electric vehicle arranged thereabove is proposed, comprising the following steps:
detecting an alignment of the charge plug relative to the socket by means of a magnetic sensor device; and
automatic positioning of the charge plug by means of a control unit on the basis of the detected alignment.

It is advantageous here that solely via the detection by means of the magnetic sensor device, sufficient information can be collected which enables a unique positioning specification of the charge plug relative to the socket. The automatic positioning of the charge plug by means of the control unit on the basis of the detected alignment has the advantage that the device may position the charge plug automatically into a socket without assistance by the operator.

According to an advantageous embodiment, the step of detecting comprises a step of moving the arm until sufficient magnet-Hall sensor pairs are detected by means of the magnetic sensor device to determine a unique position of the charge plug in relation to the socket, wherein the step of automatically positioning comprises a step of moving the charge plug from the unique position into the socket.

A unique position is to be understood in the meaning of the present disclosure as a position which is unique with respect to a two-dimensional and/or three-dimensional coordinate system. The charge plug can thus be inserted into the socket out of the unique position following a permanently implemented movement protocol, for example, and thus may be automatically positioned in the socket. The unique position may therefore be understood as a type of checkpoint. The unique position does not solely have to be based on detections of magnet-Hall sensor pairs by means of the magnetic sensor device. Alternatively or additionally, further position information may be provided, which ultimately contributes to the determination of the unique position.

According to another advantageous embodiment, the method furthermore includes the step of calculating a function of motion based on a detected magnet-Hall sensor pair, wherein the function of motion preferably includes a circular line. Generally, a circular line may be understood in the meaning of the present disclosure as a curve or a multitude of curves which comprise a circular circumference. In particular, this can be understood as a circle which extends through both magnets. In this case, this is also referred to as a charge plug circular line. Alternatively or additionally, a circular line can also be understood as a circle, the center point of which lies on a Hall sensor and the radius of which corresponds to the distance of the two Hall sensors. In this case, this is also referred to as a socket circular line. A circular line is a calculated function in the meaning of the present disclosure.

In particular, the circular line can be understood as a circle on which multiple, for example two magnets are arranged opposite. Thus, if a magnet-Hall sensor pair is detected by means of the magnetic sensor device, the arm or the charge plug may purposefully be moved translationally so that the charge plug is moved along this circular circumference above the detected Hall sensor. Depending on the arrangement, after traveling down half the circular circumference of the second magnet using the same Hall sensor, a further magnet-sensor pair may form, which is detected by means of the magnetic sensor device.

Known geometric relationships between the individual sensor components may thus be used to arrive at the unique position as efficiently as possible from a first detected magnet-Hall sensor pair. This means that the arm or the charge plug may be moved as efficiently as possible to detect a further or all further required magnet-Hall sensor pairs by means of the magnetic sensor device.

According to an advantageous embodiment, two magnets having oppositely arranged polarities are arranged on the charge plug and two bipolar analog Hall sensors are arranged on the vehicle unit, wherein the method comprises the following steps:
moving the arm until a first magnet-Hall sensor pair is detected,
calculating a circular line on the basis of the first magnet-Hall sensor pair,
moving the arm along the circular line until a second magnet-Hall sensor pair is detected,
determining the center point of the circular head end,
moving the arm until a third magnet-Hall sensor pair is detected,
determining an approach angle and calculating the position of a further magnet-Hall sensor pair,
moving the arm until the calculated position of the further magnet-Hall sensor pair is reached,
verifying the prior magnet-Hall sensor pairs,
moving the charge plug into a predefined plugging-in position and inserting the charge plug into the socket.

By way of these steps, the unique position may be produced solely via the detection of four magnet-Hall sensor pairs. A simple, robust, and contactless automatic positioning of the charge plug in the socket may thus be achieved.

Up to the last substep “inserting the charge plug into the socket”, the movement of the arm or the charge plug may take place solely in a two-dimensional plane.

Likewise, the movement of the arm or the charge plug can also take place three-dimensionally. For this purpose, for example, a step for determining a change of a signal strength can be provided. A more precise motion can thus be ensured. This can take place, for example, in that upon detection of a magnet-Hall sensor pair by means of the magnetic sensor device, the charge plug is moved in the Z direction in order to detect the change of the signal strength. Since the field strength decreases exponentially with the relative distance, the direction can be determined in which the charge plug is to be moved in order to reduce the distance. At the reduced distance, the detection and the movement may then be repeated.

The charge plug may be moved solely translationally with respect to its longitudinal axis here. Likewise, the charge plug may also be moved rotationally.

The object stated above is furthermore achieved by a computer program product having the features of claim 15. The computer program accordingly comprises product commands which, upon the execution of the program by a computing unit, prompt it to carry out the steps of the method as claimed in any one of claims 12 to 15.

### BRIEF DESCRIPTION OF THE FIGURES

Preferred further embodiments of the invention are explained in more detail by the following description of the figures. In the figures:

FIG. 1 schematically shows a device together with a ground station and a vehicle unit of an electric vehicle arranged thereabove in a side view;

FIG. 2 schematically shows the ground station together with the vehicle unit of the electric vehicle arranged thereabove from FIG. 1 in a top view;

FIG. 3 shows a detail view of the device for automatic positioning of a charge plug, arranged on a movable arm of a ground station, into a socket of a vehicle unit of an electric vehicle arranged thereabove; and

FIGS. 4A to 4E show a sequential illustration of the device from FIG. 3 to illustrate a method for automatic positioning of a charge plug of a ground station into a socket of a vehicle unit of an electric vehicle arranged thereabove.

### DETAILED DESCRIPTION OF PREFERRED EXEMPLARY EMBODIMENTS

Preferred exemplary embodiments are described on the basis of the figures hereinafter. Identical, similar, or identically acting elements are provided with identical reference signs in the different figures, and a repeated description of these elements is partially omitted to avoid redundancies.

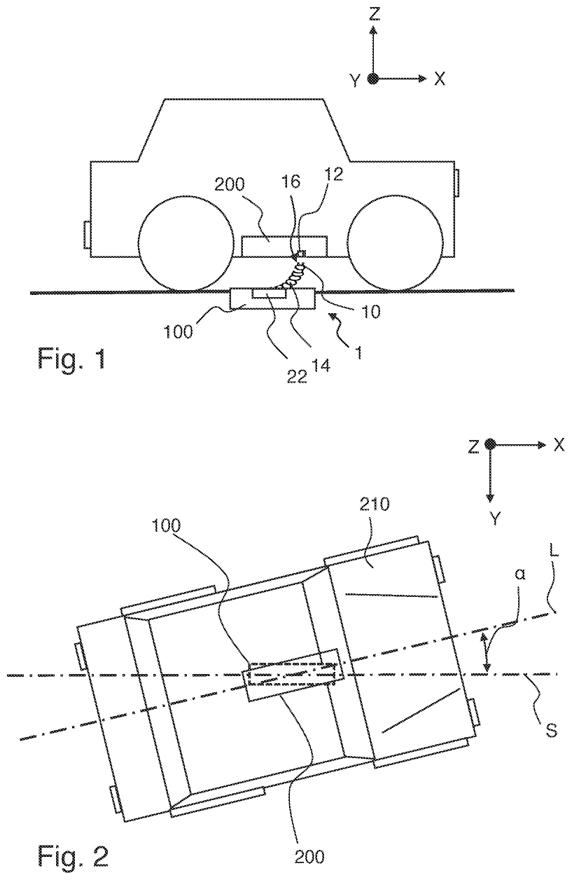

FIG. 1 schematically shows a device 1 for automatic positioning of a charge plug 10, arranged on a movable arm 14 of a ground station 100, into a socket 12 of a vehicle unit 200 of an electric vehicle 210 arranged thereabove.

The charge plug 10 may be positioned automatically into the socket 12 of the vehicle unit 200 via a movable arm 14, which is fastened in the ground station 100. The vehicle unit 200 is, in the exemplary embodiment shown, part of an electric vehicle 210 parked above the ground unit 100, which is not the subject matter of the present invention. The ground unit 100 is embedded in the ground plane, which corresponds to the X-Y plane, or rests thereon.

A control unit 22 is provided in the device 1, which is designed and configured to control the movement of the movable arm 14 and/or the charge plug 10. Furthermore, a sensor device 16 is provided in the device 1, which is embodied as a magnetic sensor device 16 and which communicates with the control unit 22 to detect the positioning of the charge plug 10 relative to the socket 12.

The magnetic sensor device 16 is designed and configured such that an alignment of the charge plug 10 relative to the socket 12 is detectable.

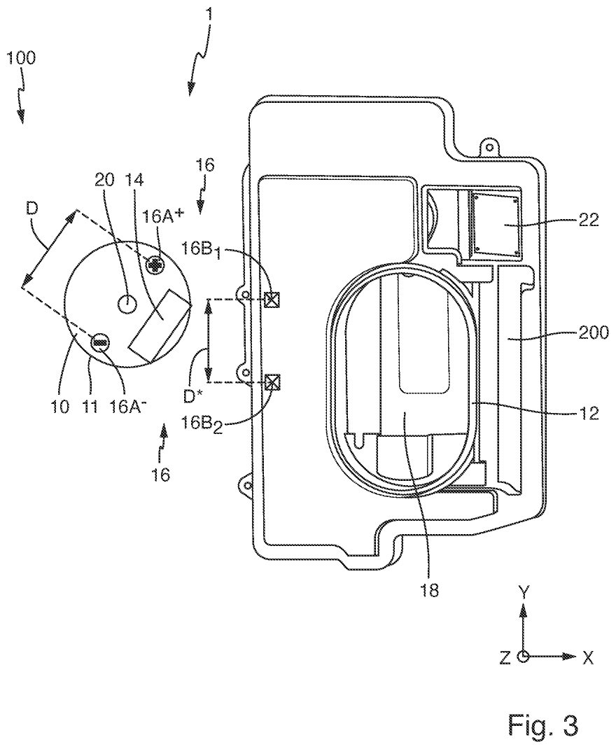

FIG. 2 schematically shows the ground station 100 together with the vehicle unit 200 of the electric vehicle 210 arranged thereabove from FIG. 1 in a top view. As can be seen from the coordinate system shown, the top view corresponds to a view of the X-Y plane. In the embodiment shown in FIG. 2, the alignment corresponds to an approach angle α formed around the Z axis, which corresponds to the parking angle or the orientation of the electric vehicle 210 (arbitrarily positioned). In other words, thus the approach angle α between the longitudinal axis L of the ground unit 200 and the longitudinal axis S of the vehicle unit 100. The ground unit 200 is shown by dashed lines.

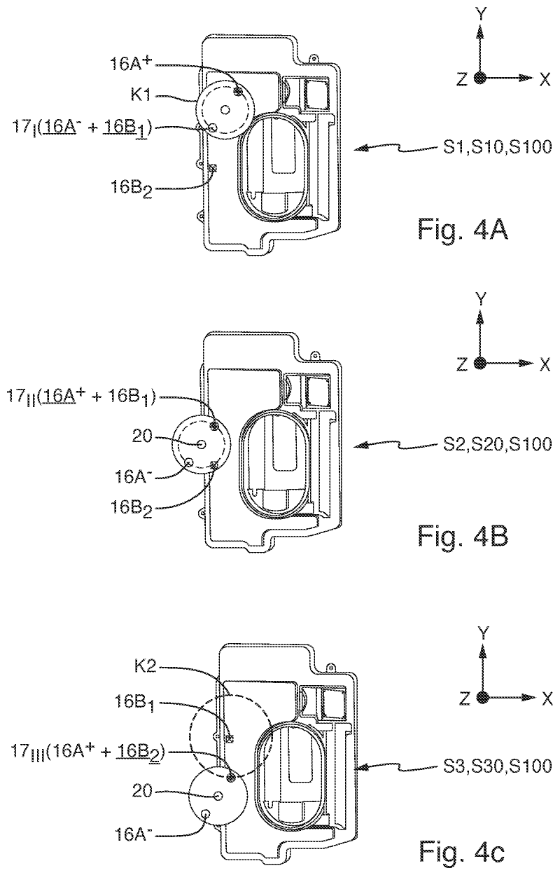

FIG. 3 shows a detail view of the device 1 for automatically positioning a charge plug 10, arranged on a movable arm 14 of a ground station 100, into a socket 12 of a vehicle unit 200 of an electric vehicle 210 arranged thereabove. As is apparent from a comparison of the coordinate systems indicated in FIG. 2 and FIG. 3, this corresponds to a view from below, thus a view which is opposite to the view from FIG. 2.

A control unit 22 is provided in the device 1, which is designed and configured to control the movement of the movable arm 14 and/or the charge plug 10. Furthermore, a magnetic sensor device 16 communicating with the control unit 22 is provided for detecting the positioning of the charge plug 10 relative to the socket 12.

The magnetic sensor device 16 is designed and configured such that an alignment of the charge plug 10 is detectable in absolute terms in relation to the socket 12. The control unit 22 is furthermore designed and configured to perform automatic positioning of the charge plug 10 relative to the socket 12 on the basis of the detected alignment.

The magnetic sensor device 16 comprises two magnets 16A and two Hall sensors 16B. The magnets 16A and the Hall sensors 16B are arranged such that in a predefined position of the charge plug 10 relative to the socket 12, one magnet-Hall sensor pair is detectable by means of the magnetic sensor device 16. In the illustration shown in FIG. 2, a magnet-Hall sensor pair is not formed, since the charge plug 10 is not located in a predefined position relative to the socket 12 according to the definition of the present disclosure. In other words, the charge plug 10 is too far away relative to the socket 12 to form a magnet-Hall sensor pair.

The magnets 16A and the Hall sensors 16B are arranged in equal proportions on the charge plug 10 and on the socket 12. Specifically, two magnets 16A are arranged on the charge plug 10 and two Hall sensors 16B are arranged on the socket 12. The magnets 16A are additionally arranged at a first distance D from one another and the Hall sensors 16B are arranged at a second distance D* from one another. The geometrical position of the socket is uniquely determinable using the Hall sensors 16B. Both the magnet and the Hall sensors can be located on the arm or in the vehicle unit.

The control unit 22 does not have to be externally accessible. The control unit 22 may also be understood as a control electronics unit and is preferably installed in the component in which the Hall sensors 16B are arranged. If the Hall sensors 16B, as shown in FIG. 3, are arranged in the vehicle unit 200, the control unit 22 is thus preferably also arranged in the vehicle unit 200.

The magnets 16A⁺, 16A⁻ have an opposing polarity, magnetic north (+), and magnetic south (−), in relation to one another, which is identified in FIG. 2 by the symbols “+” and “−”. The Hall sensors 16B are bipolar Hall sensors and are disclosed according to the depiction in FIG. 2 as a first Hall sensor 16B₁ and a second Hall sensor 16B₂. It can thus be established at each Hall sensor 16B₁ and 16B₂ via the magnetic sensor device 16 which of the two magnets 16A⁺ or 16A⁻ presently forms a magnet-Hall sensor pair. Precisely four different magnet-Hall sensor pairs are possible on the basis of the features of the device 1 disclosed in FIG. 2.

A metallic ferromagnetic plate 18 for amplifying the magnetic field is arranged behind the two Hall sensors 16B. The metallic ferromagnetic plate 18 may be embodied as an iron plate. The charge plug 10 preferably includes a circular head end 11, wherein the two magnets 16A⁺, 16A⁻, which are arranged on the charge plug 10, are supposed to be arranged symmetrically to a center point 20 of the charge plug 10.

The movable arm 14 is freely movable within a predefined virtual range of motion (not shown). The device 1 additionally includes a control unit 22 for processing signals from the magnetic sensor device 16.

Using the device 1 from FIG. 3, it is possible in principle to detect at most four different magnet-Hall sensor pairs 17 by means of the magnetic sensor device 16. The four different magnet-Hall sensor pairs 17_{I-IV} result in particular from the fact that two Hall sensors 16B₁,16B₂ spaced apart from one another are provided, and from the fact that the two provided magnets 16A⁺ and 16A⁻, which are spaced apart from one another, have an opposing polarity. On the basis of these four different magnet-Hall sensor pairs 17, a unique relative position of the plug 10 in relation to the socket 12 may be determined within a two-dimensional plane, as well as the alignment of the plug rotation position in relation to the approach angle α.

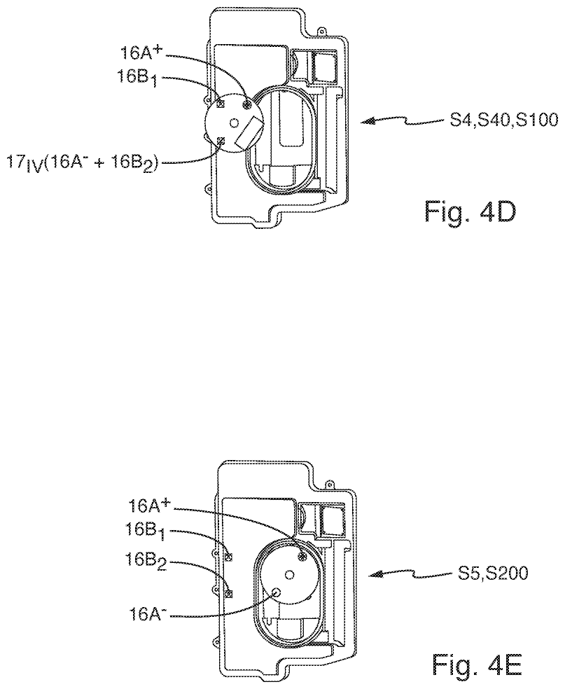

FIGS. 4A to 4E show a sequential illustration of the device from FIG. 3 to illustrate a method for automatic positioning of a charge plug 10, arranged on a movable arm 14 of a ground station 100, in a socket 12 of a vehicle unit 200 of an electric vehicle 210 arranged thereabove. The alignment of the charge plug 10 relative to the socket 12 and the view of the device is identical to FIG. 3.

The method disclosed in FIGS. 4A to 4D shows individual exemplary substeps of a method step of detecting S100 an alignment of the charge plug 10 relative to the socket 12. FIG. 4E shows a method step of automatically positioning S200 the charge plug 10 on the basis of the alignment detected in step S100. FIG. 4A shows a step S1 of a movement of the arm 14, in which a first magnet-Hall sensor pair 17_{I} is detected. Step S1 is a substep of detection step S100. Step S1 can comprise, for example, a random or systematic movement of the arm 14 along a plane which lies within the movement space of the arm 14. The movement of the arm 14 may take place solely translationally in the X-Y plane.

In the case shown in FIG. 4A, the first magnet-Hall sensor pair 17_{I} consists of the south pole magnet 16A⁻ and the first Hall sensor 16B₁. On the basis of the first magnet-Hall sensor pair 17_{I}, a circular line is calculated in a calculation step S10. In this case, the circular line may be understood as a charge plug circular line, which extends through the two magnets 16A.

FIG. 4B shows the result of a step S2, according to which the arm 14 was moved translationally along the charge plug circular line in the X-Y plane until a second magnet-Hall sensor pair 17_{II} was detected by means of the magnetic sensor device 16. The translational displacement took place in that the charge plug 10 was translationally displaced along its charge plug circular line K1 above the Hall sensor 16B₁, until the second magnet 16A⁺ is positioned directly above the same Hall sensor 16B₁. Step S2 is a substep of detection step S100.

In the case shown in FIG. 4B, the second magnet-Hall sensor pair 17_{II} thus consists of the north pole magnet 16A⁺ and the first Hall sensor 16B₁. Both magnets 16A⁺ and 16A⁻ were now detected for the first Hall sensor 16B₁. Determination step S20 is a substep of detection step S100. On the basis of these data, the center point 20 of the circular head 11 can be determined in an determination step S20. In addition, it is now known that the further, still unknown Hall sensor 16B₂ has to lie on a circle around the first Hall sensor 16B₁ having the radius D*.

FIG. 4C shows the result of a step S3, according to which a movement of the arm 14 took place until a third magnet-Hall sensor pair 17_{III} was detected by means of the magnetic sensor device 16. The movement of the arm 14 to detect the third magnet-Hall sensor pair 17_{III} may take place in that the arm 14 is moved solely translationally along a socket circular line K2, which corresponds to the circle around the first Hall sensor 16B₁ having the radius D*. The socket circular line K2 is a circle which extends through the two Hall sensors 16B₁ and 16B₂. More precisely, the arm 14 may be displaced along the socket circular line K2 such that one of the two magnets is translationally displaced along the socket circular line K2. Step S3 is a substep of detection step S100.

In the case shown in FIG. 4C, the third magnet-Hall sensor pair 17_{III} now consists of the north pole magnet 16A⁺ and the second Hall sensor 16B₂. On the basis of these data, an approach angle α (not shown) may be calculated in an determination step S30, as well as the position of the remaining magnet-Hall sensor pair 17_{IV}.

FIG. 4D shows the result of a step S4, according to which a movement of the arm 14 took place until the calculated position of the remaining magnet-Hall sensor pair 17 was reached. In a verification step S40, it may be checked whether the determined data correspond to the preceding magnet-Hall sensor pairs 17_{I-III}. Step S4 is a substep of detection step S100.

FIG. 4E shows the result of a step S5, according to which a movement of the arm 14 or the charge plug 10 into a predefined plugging-in position and insertion of the charge plug 10 into the socket 12 took place. The insertion of the charge plug 10 into the socket 12 took place in a direction orthogonal to the plane of the drawing. All other movements are to be understood in the meaning of this exemplary embodiment as two-dimensional and translational movements in the plane of the drawing. Step S5 is a substep of positioning step S200.

If applicable, all individual features which are shown in the exemplary embodiments may be combined and/or exchanged with one another without leaving the scope of the invention.

### LIST OF REFERENCE SIGNS

α Approach angle
D First distance
D* Second distance
L Longitudinal axis of the vehicle unit
S Longitudinal axis of the base unit
X,Y,Z Cartesian coordinate system
1 Device
Charge plug
11 Circular end section
12 Socket
14 Arm
16 Magnetic sensor device
17 Magnet-Hall sensor pair
17_{I-IV} First to fourth magnet-Hall sensor pair
16A Magnet
16A⁺ North pole magnet
16A⁻ South pole magnet
16B Hall sensor
16B₁ First Hall sensor
16B₂ Second Hall sensor
18 Ferromagnetic plate
20 Center point
22 Control unit
100 Ground station
200 Vehicle unit
210 Electric vehicle
S1-S4 Step of moving the arm
S5 Step of moving the charge plug
S10 Step of calculating circular line
S20 Step of determining the center point
S30 Step of determining an approach angle
S40 Step of verification
S100 Step of detection
S200 Step of positioning

1: A device for automatic positioning of a charge plug, arranged on a movable arm of a ground station, into a socket of a vehicle unit of an electric vehicle arranged thereabove,
wherein a control unit is provided, which is designed and configured to control the movement of at least one of: the movable arm and the charge plug, and a sensor device communicating with the control unit for detecting the positioning of the charge plug relative to the socket is provided, wherein
the sensor device is designed and configured such that an alignment of the charge plug relative to the socket is detectable and the control unit is designed and configured to perform automatic positioning of the charge plug relative to the socket on the basis of the detected alignment.

2: The device as claimed in claim 1, wherein the sensor device is a magnetic sensor device.

3: The device as claimed in claim 2, wherein the sensor device comprises at least two magnets and at least two Hall sensors, wherein the magnets and the Hall sensors are arranged such that a predefined position of the charge plug relative to the socket is detectable by means of the magnetic sensor device of a magnet-Hall sensor pair.

4: The device as claimed in claim 3, wherein precisely two magnets are arranged on the charge plug and precisely two Hall sensors are arranged on the socket.

5: The device as claimed in claim 3, wherein the magnets are arranged at a first distance from one another and the Hall sensors are arranged at a second distance from one another.

6: The device as claimed in claim 5, wherein the magnets have an opposing polarity to one another, wherein the Hall sensors are bipolar, analog Hall sensors.

7: The device as claimed in claim 6, wherein a ferromagnetic plate for amplifying the magnetic field is arranged behind each Hall sensor.

8: The device as claimed in claim 7, wherein the charge plug includes a circular head end, wherein the components of the magnetic sensor device, which are arranged on the charge plug, are arranged symmetrically to a center point or the pivot point of the charge plug.

9: The device as claimed in claim 8, wherein
the movable arm is movable within a predefined virtual range of motion, wherein the predefined virtual range of motion has a cross section of 300×300 mm.

10: The device as claimed in claim 9, wherein
the control device is designed and configured for processing signals of the magnetic sensor device.

11: The device as claimed in claim 10, wherein
at least one of: the ground station and the vehicle unit include communication devices for data transmission, wherein the data transmission preferably includes a wireless data transmission.

12: A method for automatic positioning of a charge plug, arranged on a movable arm of a ground station, in a socket of a vehicle unit of an electric vehicle arranged thereabove, comprising the following steps:
detecting an alignment of the charge plug relative to the socket by means of a magnetic sensor device; and
automatically positioning the charge plug by means of a control unit on the basis of the detected alignment.

13: The method as claimed in claim 12, wherein
the step of detecting comprises a step of moving the arm until sufficient magnet-Hall sensor pairs are detected by means of the magnetic sensor device to determine a unique position of the charge plug in relation to the socket, and wherein the step of automatic positioning comprises a step of moving the charge plug out of the unique position into the socket.

14: The method as claimed in claim 13, wherein the step of detecting comprises a step of calculating a function of motion, on the basis of a detected magnet-Hall sensor pair, wherein the function of motion preferably-includes a circular line.

15: The method as claimed in claim 14, wherein two magnets having opposing polarity directions are arranged on the charge plug and two bipolar analog Hall sensors are arranged on the vehicle unit, comprising the following steps:
moving the arm until a first magnet-Hall sensor pair is detected,
calculating a circular line on the basis of the first magnet-Hall sensor pair
moving the arm along the circular line, until a second magnet-Hall sensor pair is detected,
determining the center point of the circular head end,
moving the arm until a third magnet-Hall sensor pair is detected,
determining an approach angle and calculating the position of a further magnet-Hall sensor pair,
moving the arm until the calculated position of the further magnet-Hall sensor pair is reached,
verifying the prior magnet-Hall sensor pairs,
moving the charge plug into a predefined plugging-in position and inserting the charge plug into the socket.

16: A computer program product, comprising commands which, upon the execution of the program by a computing unit, prompt it to carry out the steps of:
detect an alignment of the charge plug relative to the socket by means of a magnetic sensor device; and
automatically position the charge plug by means of a control unit on the basis of the detected alignment.
